(19) United States
(12) Patent Application Publication
(10) Pub. No.: US 2023/0193052 A1
(43) Pub. Date: Jun. 22, 2023

(54) THERMAL INSULATION FELT WITH THERMAL SHOCK RESISTANCE AND PREPARATION METHOD THEREOF

(71) Applicant: SHANGHAI GUOBO NEW ENERGY TECHNOLOGY CO., LTD., Shanghai (CN)

(72) Inventors: Zhenhua LIANG, Shanghai (CN); Yongchun SUN, Shanghai (CN); Wei LU, Shanghai (CN); Sheng GUO, Shanghai (CN); Qiwei LU, Shanghai (CN); Jingtao YAN, Shanghai (CN); Lingshuang XU, Shanghai (CN)

(21) Appl. No.: 17/848,635

(22) Filed: Jun. 24, 2022

Related U.S. Application Data
(63) Continuation of application No. PCT/CN2022/070741, filed on Jan. 7, 2022.

(30) Foreign Application Priority Data
Dec. 22, 2021 (CN) 202111579939.4

(51) Int. Cl. C09D 5/18; F16L 59/02; H01M 10/658; C09D 7/48; C09D 7/65; C09D 1/00

(52) U.S. Cl. CPC C09D 5/18; F16L 59/029; H01M 10/658; C09D 7/48; C09D 7/65; C09D 1/00

(57) ABSTRACT

The present application relates to a thermal insulation felt with thermal shock resistance and a preparation method thereof. A thermal insulation felt with thermal shock resistance has a layered structure, and includes a glass fiber layer with filler and a thermal shock-resistant coating, in which the thermal shock-resistant coating is coated on one or two sides of the glass fiber layer with filler. The filler is hollow glass bead or aerogel SiO₂. The thermal shock-resistant coating is obtained by coating a thermal shock-resistant coating material on one or two sides of the glass fiber layer with filler and then drying and solidifying. The thermal shock-resistant coating material, based on a weight percentage, includes 10-50% SiO₂, 5-60% ZnO, 5-40% Al₂O₃, 5-15% poly tetra fluoroethylene, 5-35% silane coupling agent and 15-50% phosphate.

### CROSS-REFERENCE TO RELATED APPLICATIONS

This application is a continuation of PCT application serial no. PCT/CN2022/070741, filed on Jan. 7, 2022, which claims the priority and benefit of Chinese patent application serial no. 202111579939.4, filed on Dec. 22, 2021. The entirety of PCT application serial no. PCT/CN2022/070741 and Chinese patent application serial no. 202111579939.4 are hereby incorporated by reference herein and made a part of this specification.

### TECHNICAL FIELD

The present application relates to the technical field of thermal insulation materials, and particularly to a thermal insulation felt with thermal shock resistance and preparation method thereof.

### BACKGROUND ART

Battery electric vehicle (BEV) refers to a vehicle with advanced technical principles, new technologies and new structures, which uses on-board power supply as power, drives wheels by motor, and integrates advanced technologies in vehicle power control and driving. The battery electric vehicle has the advantage of green and is also regarded as the development trend of future automotive industry, so that an important component of this kind of automobile is a storage battery. Therefore, a thermal insulation felt and other materials are often used to wrap the outside of the storage battery for thermal insulation protection or thermal insulation between lithium batteries.

In related technology, a thermal insulation felt is disclosed as a glass fiber felt composite material, which includes an aerogel felt and a polyethylene layer arranged between the two layers aerogel felts. The thermal insulation felt of the composite material has excellent thermal insulation performance, so that it can achieve the purpose of thermal insulation and protection of the battery. However, the thermal shock resistance of the thermal insulation felt of the above composite material is weak. When the thermal insulation felt is subjected to severe temperature changes or alternates between cold and hot in a certain initial temperature range, structures of the aerogel felt and the polyethylene layer can easily be destroyed, so that its thermal insulation and protection effect are significantly reduced. Therefore, the thermal insulation felt should be regularly inspected or replaced, so that it brings great inconvenience to users.

In summary, although the current thermal insulation felt has excellent thermal insulation and protection function, its thermal shock resistance is weak.

### SUMMARY

In order to solve the above technical problem, the present application provides a thermal insulation felt with thermal shock resistance and preparation method thereof, so that the thermal insulation can not only have thermal insulation performance, but also have excellent thermal shock resistance

In a first aspect, a thermal insulation felt with thermal shock resistance provided in the present application adopts the following technical solution:

a thermal insulation felt with thermal shock resistance having a layered structure including a glass fiber layer with filler and a thermal shock-resistant coating, in which the thermal shock-resistant coating is coated on one or two sides of the glass fiber layer with a filler;

the filler is a hollow glass bead or aerogel SiO₂;

the thermal shock-resistant coating is a coating obtained by coating a thermal shock-resistant coating material on one or two sides of the glass fiber layer with the filler and then drying and solidifying; and

the thermal shock-resistant coating material, calculated as a percentage by weight, comprises 10-50% of SiO₂, 5-60% of ZnO, 5-40% of Al₂O₃, 5-15% of poly tetra fluoroethylene (hereinafter referred to as PTFE), 5-35% of silane coupling agent, and 15-50% of phosphate.

In the above technical solution, the thermal insulation felt with the glass fiber layer as a base layer has excellent thermal shock resistance basing on thermal insulation protection through the filler filled in the glass fiber layer and the thermal shock-resistant coating coated on the two opposite sides of the glass fiber layer.

The filler not only strengthens the mechanical properties of the glass fiber layer, but also enhances overall high-temperature resistance of the glass fiber layer enhanced by high-temperature resistance of the materials itself. Thus, the thermal insulation felt is not easy to deform when subjected to severe temperature changes, and has strong structural stability to ensure high-temperature resistance and heat insulation performance of the thermal insulation felt.

The thermal shock-resistant coating protects and reinforces the glass fiber layer on an outside thereof, which reduces an influence of temperature on the glass fiber layer and renders its internal structure not easy to be damaged due to severe temperature changes. Compared with a thermal insulation felt without a thermal shock-resistant coating, its thermal conductivity decreases by 35-85% at 25° C., and a breaking time under 1000° C. and 5 Bar air pressure is prolonged by 77-210%. It can be seen that the thermal shock-resistant coating significantly improves the thermal insulation performance and thermal shock resistance of the thermal insulation felt.

Optionally, the thermal shock-resistant coating has a coating thickness of 0.02-1.5 mm A process condition of the drying and solidifying comprises a temperature of 250-500° C. and a heating time of 1-5 h.

In the above technical solution, a compound effect between the thermal shock-resistant coating solidified at above temperature and heating time and the glass fiber layer is better. The reason is that the thermal shock-resistant coating can infiltrate into the glass fiber layer at the above process conditions. Therefore, after solidifying, it can effectively reduce temperature influence on the glass fiber layer.

When the temperature and heating time are higher than those in the above process conditions, the thermal insulation effect is lost. The reason is that most of the thermal shock-resistant coating infiltrates into the glass fiber layer, so that the thermal shock-resistant coating remained on the surface of the glass fiber layer cannot effectively stop temperature influence. And in the condition of the above temperature, the glass fiber may be softened slightly and its inner structure can be changed.

For the purpose of balancing an actual use demand and a production cost, the coating thickness is 0.02-1.5 mm. In use, a larger thickness can be selected, which shall not be regarded as limiting the present application.

Optionally, a phosphate in the thermal shock-resistant coating material is one or more selected from a group consisting of dihydrogen phosphate, hydrogen phosphate, orthophosphate and metaphosphate.

In the above technical solution, the phosphate of the above components is a refractory material with acid orthophosphate or polycondensate as a main compound and has gelling performance After the phosphate is heated, the phosphoric acid component can react and combine with alkali-metal or amphoteric oxide and its hydroxide and play a role of coagulating and hardening. Thus, the thermal shock-resistant coating is provided with excellent thermal shock resistance.

When a variety of phosphates are used in combination, the formed three-dimensional cross-linked structure is cross connected with each other, which significantly improves its bonding force, and effectively play a role of coagulating and hardening, thereby ensuring the thermal shock resistance of the thermal shock-resistant coating.

Optionally, the glass fiber layer is a glass fiber cloth or a glass fiber felt, and the glass fiber cloth or glass fiber felt is made of glass fiber. The glass fiber layer has a thickness of 1.0-3.0 mm, and a weaving density of warps or wefts of 15-30 pieces/cm.

In the above technical solution, when using the above glass fiber cloth and glass fiber felt as the glass fiber layer, they are all have the excellent usage effect, and the thickness is larger, the thermal insulation performance is better. If the weaving density is too low, there are few binding sites for glass beads. If the weaving density is too high, it will hinder the injection of glass beads, which will lead to a decline of thermal insulation and temperature resistance of thermal insulation felt. Compared with glass fiber cloth, gaps between fibers of glass fiber felt are more disordered, which is beneficial to thermal insulation performance and weight reducing, but leads to a reduced tensile strength.

Optionally, the glass fiber is a continuous glass fiber with a diameter of 6-24 μm, and is one or more selected from a group consisting of Z-Tex Series: Z-Tex™, Z-Tex Plus™, Z-Tex Super™ and Z-Tex Ultra™.

In the above technical solution, the glass fiber layer woven from the above types of glass fiber has a compact and stable structure after being filled with glass beads and is not easy to deform due to heating and other reasons, and it can provide more binding sites for the thermal shock-resistant coating, so that the combination of thermal shock-resistant coating is denser. In particular, when Z-Tex ultra is used, the glass fiber has a better performance, including high tensile strength, high-temperature resistance, and better thermal shock resistance.

Optionally, calculated as a percentage by weight, the hollow glass bead includes: 50-80% of SiO₂, 10-70% of Al₂O₃ and 10-30% of ZrO₂.

In the above technical solution, the above filler can not only combine with the glass fiber layer, but also endow the glass fiber layer with excellent high-temperature resistance and thermal insulation performance.

Optionally, the hollow glass bead has a diameter of less than or equal to 100 μm. A weight ratio of the hollow glass beads to glass fiber cloth or glass fiber felt is 1:(3-7) in use.

The above technical solution can further ensure a filling compactness and strength between the hollow glass beads and the glass fiber layer, without affecting the uniformity and bonding strength of the coating, thereby ensuring the high-temperature resistance and thermal insulation performance of the glass fiber layer.

Optionally, the silane coupling agent is one or more selected from a group consisting of KH-550, KH-570, KH602, KH792 and Sj-42.

In the above technical solution, the silane coupling agent of the above components can effectively improve the connection strength between the thermal shock-resistant coating and the glass fiber layer. Then, the thermal shock-resistant coating can be firmly bonded on two sides of the glass fiber layer and play a role of protection and thermal insulation. In addition, when a plurality of groups of silane coupling agents are combined, a cross connected three-dimensional spatial structure can be formed, which has a firmer structure and a better viscosity.

In a second aspect, the present application provides a preparation method of a thermal insulation felt with thermal shock resistance, which adopts the following technical solution:

a preparation method of thermal insulation felt with thermal shock resistance, including the following steps:

S1. preparing a glass fiber layer:

1) if the glass fiber layer is a glass fiber cloth, the glass fiber cloth is obtained by a textile method;

2) if the glass fiber layer is a glass fiber felt, the glass fiber felt is prepared by any of needling, wet method and dry method;

S2. preparing the glass fiber layer with a filler: injecting the filler into the glass fiber layer to obtain the glass fiber layer with filler; and

S3. preparing the thermal shock-resistant coating: coating a thermal shock-resistant coating material on two opposite sides of the glass fiber layer with filler by any method of roller coating, calendering or scrap coating; the coating thickness is 0.02-1.0 mm, then the temperature is controlled to 250-500° C. for solidifying for 1-5 h to obtain the thermal insulation felt with thermal insulation performance.

In the above technical solution, the thermal insulation felt prepared by the above process has stable and uniform performance and excellent thermal insulation performance. It can not only meet the needs of downstream industries, but also easily prepare in an overall process and suit for mass industrial production.

In a third aspect, the present application provides a thermal shock-resistant coating material adopting the following technical solution:

a thermal shock-resistant coating material, calculated as a percentage by weight, including: 10-50% SiO₂, 5-60% ZnO, 5-40% Al₂O₃, 5-15% PTFE, 5-35% silane coupling agent and 15-50% phosphate.

In the above technical solution, the thermal shock-resistant coating material with the above components can be dried and solidified on outside of the glass fiber layer to form a thermal shock-resistant coating to protect the glass fiber layer. It not only ensures the thermal shock resistance of the thermal insulation felt, but also reduces the temperature influence of the glass fiber layer, so that the glass fiber layer is not easy to be damaged due to the severe temperature changes.

In summary, the present application has the following beneficial effects.

1. By providing the filler and the thermal shock coating, the thermal insulation felt in present application has excellent mechanical properties and thermal insulation performance. When the thermal insulation felt undergoes severe temperature changes or high-temperatures, it is not easy to be damaged due to a deformation of internal structure.

2. The preparation method of the present application is relatively simple, which is suitable for industrialized large-scale production; and at the same time, the thermal insulation performance and mechanical properties of obtained product are excellent, which can meet actual needs of downstream applications.

3. The thermal shock-resistant coating material of the present application has excellent thermal shock resistance. After drying and solidifying on the surface of glass fiber layer, it can effectively ensure its thermal insulation performance and thermal shock resistance.

4. The thermal insulation felt finally obtained in this present application can be applied in the fields of thermal insulation materials such as the thermal insulation protection of new energy vehicle batteries and national defense and aviation materials, the preservation of medical and health supplies and building thermal insulation materials, and also has a better thermal insulation performance.

### DETAILED DESCRIPTION

The present application will be further described in detail below in combination with the examples.

The raw material used in examples of the present application are commercially available except for the following special instructions:

SiO₂, ZnO and Al₂O₃, with a particle size of 2-10 μm, are purchased from Sinopharm Chemical Reagent Co., Ltd.

PTFE, polymerization degree is (60-200)*10⁴, is purchased from Sinopharm Chemical Reagent Co., Ltd;

Hollow glass beads, particle size ≤100 μm, are purchased from Minnesota Mining and machinery manufacturing company; and

Z-Tex Series: Z-Tex™, Z-Tex Plus™, Z-Tex Super™, Z-Tex Ultra™, are purchased from Shanghai Guobo Automotive Technology Co., Ltd, and their performance is as follows:

| Z-Tex Series | Z-Tex ™ | Z-Tex plus ™ | Z-Tex super ™ | Z-Tex ultra ™ |
|---|---|---|---|---|
| Length (mm) | Continuous yarn, cuttable | | | |
| Diamete (μm) | 6-24 | 6-24 | 6-24 | 6-24 |
| Softening | 905-915 | 920-930 | 945-950 | 1500 |
| temperature | | | | |
| (° C.) | | | | |
| Long term | 760 | 790 | 820 | 1000 |
| temperature | | | | |
| resistance | | | | |
| (° C.) | | | | |

### Performance Test

The thermal insulation felts made in examples and comparative examples are selected as the test objects, and the thermal insulation performance and thermal shock resistance of each groups are tested respectively. The test steps are as follows:

1) Thermal Insulation Performance Test:

the thermal insulation felt of the groups to be tested are processed into five pieces as five samples, and a size of each sample is 50 mm*50 mm*2.5 mm samples. A thermal conductivity instrument (model Hot Disk TPS 2500S, purchased from Sweden Hot Disk company) is used for testing.

Test steps: firstly, five samples are stacked and put into the sample clamp and clamped. Then “Confirm” and “Start Test” on an operation interface of the thermal conductivity instrument are clicked to start the test, and the test results are averaged.

2) Thermal Shock Resistance Test

The thermal insulation felt of the groups to be tested are processed into five samples with 50 mm*50 mm*2.5 mm, a flame spray gun with air pressure is used to test the thermal shock resistance, a flame temperature is adjusted to 1000° C. and an air pressure is adjusted to 5 Bar. One side of a sample coated with thermal shock-resistant coating is tested, time when the samples fail are recorded, that is, the hole appears in the sample, and the test results are averaged.

### EXAMPLES

### Example 1

a thermal insulation felt with thermal insulation shock resistance was composed of a glass fiber layer with filler and a thermal shock-resistant coating coated on two opposite sides of the glass fiber layer with a filler;

the filler was a hollow glass bead with 50 μm particle size, calculated as a percentage by weight, a composition and content of raw materials were as follows: 80% SiO₂, 10% Al₂O₃, 10% ZrO₂;

the thermal shock-resistant coating was obtained by coating a thermal shock-resistant coating material on the two opposite sides of a glass fiber layer with filler and then drying and solidifying; and

the thermal shock-resistant coating material, calculated as a percentage by weight, whose composition and content of raw materials were as follows: 25% SiO₂, 30% ZnO, 5% Al₂O₃, 5% PTFE, 15% silane coupling agent, and 20% phosphate;

wherein the silane coupling agent was KH-550, and the phosphate was dihydrogen phosphate.

A preparation method of the thermal insulation felt with thermal shock resistance included the following steps:

S1. preparing a glass fiber layer:

the glass fiber layer was a glass fiber cloth obtained by a textile method. The glass fiber cloth can be prepared after the glass fiber was initially twisted, warped in batches, threaded and woven by a loom. In particular, the used glass fiber was Z-Tex™ with 25 mm lengths and 10 μm diameter. A thickness of the glass fiber cloth was 2.0 mm, and a weaving density of warp or weft was 15 pieces/cm.

S2. preparing a glass fiber layer with a filler:

firstly, the glass fiber layer was placed in a closed circular mold with pipes, then the air pressure was controlled to 10 Bar. The filler was filled into a gap of the glass fiber layer through eight groups of evenly arranged pipes with a weight ratio of 1:5 to obtain a glass fiber layer with the filler;

S3. preparing a thermal shock-resistant coating: a thermal shock-resistant coating was coated by roller coating, calendering or scraping on two sides of the glass fiber layer with the filler. This example takes roller coating as an example, and the specific steps were as follows:

raw materials required to form a thermal shock-resistant coating material were mixed evenly, then the thermal shock-resistant coating material obtained was placed in a slurry tray of a roller coating equipment. Then the roller coating equipment was started, and two opposite sides of the glass fiber layer with filler was coated. coating thicknesses of the two opposite sides were same and the coating thickness was 0.3 mm.

After coating, a solidifying temperature was controlled to 250° C. and cured for 1 h, and a thermal insulation felt with thermal shock resistance was obtained. An actual thickness of the thermal shock-resistant coating was determined to be 0.15 mm.

### Examples 2-8

The difference of a thermal insulation felt with thermal shock resistance from Example 1 lied in that the components and corresponding weight of the thermal shock-resistant coating material were different, calculated as 100 kg, as shown in Table 1, and the others were the same as Example 1.

TABLE 1
components and corresponding weight of the thermal shock-
resistant coating material in Examples 1-8 (kg)

| | Examples | | | | | | | |
|---|---|---|---|---|---|---|---|---|
| Components | 1 | 2 | 3 | 4 | 5 | 6 | 7 | 8 |
| SiO₂ | 25 | 25 | 40 | 30 | 20 | 20 | 50 | 10 |
| ZnO | 30 | 15 | 20 | 15 | 15 | 10 | 5 | 60 |
| Al₂O₃ | 5 | 10 | 5 | 15 | 20 | 25 | 5 | 5 |
| PTFE | 5 | 5 | 5 | 10 | 15 | 15 | 5 | 5 |
| silane coupling agent | 15 | 25 | 10 | 10 | 5 | 5 | 20 | 5 |
| phosphate | 20 | 20 | 20 | 20 | 25 | 25 | 15 | 15 |

### Comparative Example 1

A thermal insulation felt was the same as Example 1 except that it didn't include the thermal shock-resistant coating coated on two sides of the glass fiber layer with the filler.

### Comparative Example 2

A thermal insulation felt was the same as Example 1 except that ZnO in the thermal shock-resistant coating material was replaced by an equal amount of B₂O₃.

### Comparative Example 3

A thermal insulation felt was the same as Example 1 except that Al₂O₃ in the thermal shock-resistant coating material was replaced by an equal amount of B₂O₃.

### Comparative Example 4

A thermal insulation felt was the same as Example 1 except that the thermal shock-resistant coating material used for making the thermal shock-resistant coating was composed of the following weight percentage components: 5% SiO₂, 10% ZnO, 10% Al₂O₃, 20% PTFE, 45% silane coupling agent, and 10% phosphate.

### Comparative Example 5

A thermal insulation felt was the same as Example 1 except that the thermal shock-resistant coating material used for making the thermal shock-resistant coating was composed of the following weight percentage components: 5% SiO₂, 20% Al₂O₃, 20% PTFE, 45% silane coupling agent, and 10% phosphate.

The thermal insulation performance and thermal shock resistance of the thermal insulation felt obtained in Examples 1-8 and Comparative Examples 1-5 above were tested. The measurement results were shown in the following table:

| | Test items | |
|---|---|---|
| | Thermal insulation | Thermal shock |
| | performance | resistance |
| | Thermal | Breakage time |
| | conductivity | under 1000° C. |
| Groups | W/(K · m)@25° C. | and 5 Bar (min) |
| Example 1 | 0.035 | 85 |
| Example 2 | 0.04 | 65 |
| Example 3 | 0.03 | 93 |
| Example 4 | 0.04 | 70 |
| Example 5 | 0.045 | 62 |
| Example 6 | 0.05 | 60 |
| Example 7 | 0.09 | 58 |
| Example 8 | 0.13 | 53 |
| Comparative Example 1 | 0.20 | 30 |
| Comparative Example 2 | 0.16 | 35 |
| Comparative Example 3 | 0.21 | 32 |
| Comparative Example 4 | 0.18 | 33 |
| Comparative Example 5 | 0.25 | 30 |

It can be seen from the above table that the thermal insulation felt with thermal shock resistance obtained in Examples 1-8 had better thermal insulation performance and thermal shock resistance. The thermal conductivity at 25° C. was only 0.03-0.13 W/(K·m), and the breaking time at 1000° C. and 5 Bar pressure was up to 53-93 min. This showed that due to the existence of inner and outer thermal shock-resistant coating, the thermal insulation felt with thermal shock resistance of the present application can not only ensure the thermal insulation performance of the thermal insulation felt, but also effectively improve the thermal shock resistance of the thermal insulation felt. The reason is that: the thermal shock-resistant coating material with the above specific components was coated on two sides of the glass fiber layer with filler to form inner and outer thermal shock-resistant coatings with dense structure and high strength, which can effectively protect and strengthen the glass fiber layer. The inner glass fiber layer structure was not easily affected by temperature.

In addition, the thermal insulation felt with thermal shock resistance obtained in Example 4 had excellent thermal insulation performance and thermal shock resistance. The thermal conductivity at 25° C. was only 0.03 W/(K·m), and the breaking time at 1000° C. and 5 Bar pressure was up to 93 min.

It can be further seen from the above table that, compared with Example 1, since the thermal insulation felt of Comparative Example 1 didn't contain the thermal shock-resistant coating, its thermal conductivity at 25° C. was as high as 0.20 W/(K·m), which was 566% higher than that of Example 1. The breaking time at 1000° C. and 5 Bar pressure was only 30 min, which was 68% shorter than that in Example 1.

It can be seen that, lack of sealing and strength support provided by inner and outer thermal shock-resistant coatings, the thermal insulation felt still had certain thermal insulation performance and thermal shock resistance, but the thermal insulation performance and thermal shock resistance were not as good as the thermal insulation felt with thermal shock resistance of the present application.

It can be further seen from the above table that, compared with Example 1, the thermal conductivity of the thermal insulation felt obtained in Comparative Examples 2-3 at 25° C. was as high as 0.16-0.21 W/(K·m), which was 357-500% higher than that of Example 1. The breaking time at 1000° C. and 5 Bar pressure was only 32-35 min, which was 62-66% shorter than that in Example 1. It can be further seen from the above table that, compared with Example 1, the thermal conductivity of the thermal insulation felt obtained in Comparative Examples 4-5 at 25° C. was as high as 0.18-0.25 W/(K·m), which was 414-614% higher than that of Example 1. The breaking time at 1000° C. and 5 Bar pressure was only 30-33 min, which was 65-68% shorter than that in Example 1.

This shows that only when the thermal shock-resistant coating material with specific composition and content was coated on two opposite sides of the glass fiber layer with filler, the inner and outer heat shock resistant layers with dense structure and high strength can be formed. Different components or contents will affect the compact structure and impact strength of the thermal shock-resistant coating, so that the thermal insulation performance and thermal shock resistance of the thermal insulation felt were significantly decreased.

In summary, the thermal insulation felt of the glass fiber layer with filler was made of the glass fiber layer with filler. The thermal insulation felt had excellent thermal shock resistance on the basis of thermal insulation protection through the filler glass beads filled in the glass fiber layer and the thermal shock-resistant coatings coated on the inner and outer sides. In particular, the filler glass beads can improve the performance of the glass fiber layer through its high-temperature resistance and strength, and the thermal shock-resistant coating on the inner and outer sides can protect and strengthen the glass fiber layer, thereby reducing the possibility of internal structure damage of the glass fiber layer caused by severe temperature changes.

### Example 9

A thermal insulation felt with thermal shock resistance, which was the same as Example 1 except that the thermal shock-resistant coating was only coated on one side of the glass fiber layer with filler.

The performance test of the thermal insulation felt obtained in above Example 9 was tested, and its thermal insulation performance and thermal shock resistance were tested respectively. The average values of the measurement results were taken and recorded in the following table:

| | Test items | |
|---|---|---|
| | Thermal insulation | Thermal shock resistance |
| | performance | Breakage time |
| | Thermal conductivity | under 1000° C. |
| Groups | W/(K · m)@25° C. | and 5 Bar (min) |
| Example 1 | 0.035 | 85 |
| Example 9 | 0.038 | 75 |

It can be seen from the above table that the thermal insulation felt obtained in Example 9 had better thermal insulation performance and thermal shock resistance. The thermal conductivity at 25° C. was only 0.038 W/(K·m), which was only reduced by 0.003 W/(K·m) than that of Example 1. The breaking time at 1000° C. and 5 Bar pressure was up to 75 min, which was only reduced by 10 min than that of Example 1.
It showed that only one side of the thermal shock-resistant coating also can improve the thermal insulation performance and thermal shock resistance of thermal insulation felt. The coating condition mainly depended on an actual application environment, that was, a location of the battery to be protected can be adjusted based on an actual use demand and production cost, which should not be regarded as limiting the application.

### Example 10

A thermal insulation felt with thermal shock resistance was the same as Example 1 except that the coating process of thermal shock-resistant coating in step S3 was different, the details were as follows:

the coating thickness of the thermal shock-resistant coating was 0.1 mm After the thermal shock-resistant coating material was coated on two sides of the glass fiber layer, it was solidified at 250° C. for 1 h. After testing, the actual thickness of the thermal shock-resistant coating after final drying and solidifying was 0.05 mm.

### Example 11

A thermal insulation felt with thermal shock resistance was the same as Example 1 except that the coating process of thermal shock-resistant coating in step S3 was different, the details were as follows:

the coating thickness of the thermal shock-resistant coating was 1.0 mm After the thermal shock-resistant coating material was coated on two sides of the glass fiber layer, it was solidified at 250° C. for 1 h. After testing, the actual thickness of the thermal shock-resistant coating after final drying and solidifying was 0.5 mm.

### Example 12

A thermal insulation felt with thermal shock resistance is the same as Example 1 except that the coating process of thermal shock-resistant coating in step S3 was different, the details were as follows:

the coating thickness of the thermal shock-resistant coating was 2.0 mm After the thermal shock-resistant coating material is coated on two sides of the glass fiber layer, it was solidified at 250° C. for 1 h. After testing, the actual thickness of the thermal shock-resistant coating after final drying and solidifying was 1.0 mm.

### Example 13

A thermal insulation felt with thermal shock resistance was the same as Example 1 except that the coating process of thermal shock-resistant coating in step S3 was different, the details were as follows:

the coating thickness of the thermal shock-resistant coating was 0.3 mm After the thermal shock-resistant coating material was coated on two sides of the glass fiber layer, it was solidified at 250° C. for 5 h. After testing, an actual thickness of the thermal shock-resistant coating after final drying and solidifying was 0.15 mm.

### Example 14

A thermal insulation felt with thermal shock resistance was the same as Example 1 except that the coating process of thermal shock-resistant coating in step S3 was different, the details were as follows:

the coating thickness of the thermal shock-resistant coating was 0.3 mm After the thermal shock-resistant coating material was coated on two sides of the glass fiber layer, it was solidified at 500° C. for 1 h. After testing, an actual thickness of the thermal shock-resistant coating after final drying and solidifying was 0.15 mm.

### Example 15

A thermal insulation felt with thermal shock resistance was the same as Example 1 except that the coating process of thermal shock-resistant coating in step S3 was different, the details were as follows:

the coating thickness of the thermal shock-resistant coating was 0.3 mm After the thermal shock-resistant coating material was coated on two sides of the glass fiber layer, it was solidified at 600° C. for 6 h. After testing, the actual thickness of the thermal shock-resistant coating after final drying and solidifying was 0.15 mm.

The performance test of the thermal insulation felt obtained in above Examples 10-15 were tested, and their thermal insulation performance and thermal shock resistance were tested respectively. The average values of the measurement results were taken and recorded in the following table:

| | Test items | |
|---|---|---|
| | Thermal insulation | Thermal shock resistance |
| | performance | Breakage time |
| | Thermal conductivity | under 1000° C. |
| Groups | W/(K · m)@25° C. | and 5 Bar (min) |
| Example 1 | 0.035 | 85 |
| Example 10 | 0.060 | 50 |
| Example 11 | 0.032 | 88 |
| Example 12 | 0.028 | 95 |
| Example 13 | 0.050 | 56 |
| Example 14 | 0.056 | 53 |
| Example 15 | 0.11 | 38 |

It can be seen from the above table that the thermal insulation felt with thermal shock resistance obtained in Examples 10-14 had better thermal insulation performance and thermal shock resistance. The thermal conductivity at 25° C. was only 0.028-0.060 W/(K·m), and the breaking time at 1000° C. and 5 Bar pressure was up to 50-95 min. This showed that the thermal shock-resistant coating was solidified under the above coating thickness, temperature and heating time had a good composite effect with the glass fiber layer. The reason analyzed was that the thermal shock-resistant coating can partially penetrate into the glass fiber layer under the above process conditions, and then after solidifying, it can effectively reduce the influence of temperature on the glass fiber layer.

Especially when the temperature was higher than 500° C. and the heating time was longer than 5 h, the thermal insulation effect will be significantly reduced. In Example 15, the thermal conductivity at 25° C. was as high as 0.11 W/(K·m), and the breaking time at 1000° C. and 5 Bar air pressure was only 38 min. It was speculated that the reason was that most of the thermal shock-resistant coating penetrates into the glass fiber layer, so that the thermal shock-resistant coating on the surface of the glass fiber layer cannot effectively isolate the influence of temperature on the glass fiber layer, and the glass fiber was slightly softened and its internal structure changes under the above temperature conditions.

It can be further seen from the above table that the thermal insulation felt obtained in Example 12 has better thermal insulation performance and thermal shock resistance. The thermal conductivity at 25° C. was only 0.028 W/(K·m), and the breaking time at 1000° C. and 5 Bar pressure was up to 95 min. It can be known that Example 12 was the best example, the thermal shock-resistant coating coated under this process condition can effectively reduce the influence of external temperature on the glass fiber layer, thereby significantly improving the performance of thermal insulation felt.

In summary, the thermal shock-resistant coating cured under the above temperature and heating time had a good composite effect with the glass fiber layer, which was protected and reinforced on the outside of the glass fiber layer, the glass fiber layer was reduced by temperature at the same time, so that the internal structure of the glass fiber layer was not easy to be destroyed due to severe temperature changes, then, which had excellent thermal insulation performance and thermal shock resistance.

### Example 16

A thermal insulation felt with thermal shock resistance was same as Example 1 except that the phosphate in the thermal shock-resistant coating was composed of dihydrogen phosphate and hydrogen phosphate according to the weight ratio of 1:1.

### Example 17

A thermal insulation felt with thermal shock resistance was same as Example 1 except that the phosphate in the thermal shock-resistant coating was composed of dihydrogen phosphate and orthophosphate according to the weight ratio of 1:1.

### Example 18

A thermal insulation felt with thermal shock resistance was same as Example 1 except that the phosphate in the thermal shock-resistant coating was composed of dihydrogen phosphate, hydrogen phosphate and orthophosphate according to the weight ratio of 1:1:1.

### Example 19

A thermal insulation felt with thermal shock resistance was same as Example 1 except that the phosphate in the thermal shock-resistant coating was composed of dihydrogen phosphate, hydrogen phosphate, orthophosphate and metaphosphate according to a weight ratio of 1:1:1:1.

The performance test of the thermal insulation felt obtained in above Examples 16-19 were tested, and their thermal insulation performance and thermal shock resistance were tested respectively. The average values of the measurement results were recorded in the following table:

| | Test items | |
|---|---|---|
| | Thermal insulation | Thermal shock resistance |
| | performance | Breakage time |
| | Thermal conductivity | under 1000° C. |
| Groups | W/(K · m)@25° C. | and 5 Bar (min) |
| Example 1 | 0.035 | 85 |
| Example 16 | 0.035 | 86 |
| Example 17 | 0.033 | 89 |
| Example 18 | 0.034 | 88 |
| Example 19 | 0.031 | 91 |

It can be seen from the above table that the thermal insulation felt obtained in Examples 16-19 had better thermal insulation performance and thermal shock resistance. The thermal conductivity at 25° C. was only 0.031-0.035 W/(K·m), and the breaking time at 1000° C. and 5 Bar pressure was up to 85-91 min. This showed that the phosphate of the above components can ensure the strength and density of the coating, thereby rendering the thermal shock resistant coating excellent thermal shock resistance.

It also can further be seen from the above table that the thermal insulation felt made in Example 19 had better thermal insulation performance and thermal shock resistance. The thermal conductivity at 25° C. was only 0.031 W/(K·m), and the breaking time at 1000° C. and 5 Bar pressure was up to 91 min. This showed that Example 19 was the best example, when the phosphate in the thermal shock-resistant coating was composed of dihydrogen phosphate, hydrogen phosphate, orthophosphate and metaphosphate in the weight ratio of 1:1:1:1, the performance of the thermal shock-resistant coating was the best.

In summary, a compounding of different types of phosphates were conducive to a compounding between different phosphate molecules in a certain extent. A three-dimensional cross-linking structure formed by the compounding can not only significantly improve its adhesion, but also promote its condensation and hardening effect, thereby ensuring the strength and density of the coating and rendering the thermal shock resistant coating with excellent heat shock resistance.

### Example 20

A thermal insulation felt with thermal shock resistance was same as Example 1 except that the thickness of the obtained glass fiber cloth was 1.0 mm and the weaving density of warp or weft was 15 pieces/cm.

### Example 21

A thermal insulation felt with thermal shock resistance was same as Example 1 except that the thickness of the obtained glass fiber cloth is 3.0 mm and the weaving density of warp or weft is 15 pieces/cm.

### Example 22

A thermal insulation felt with thermal shock resistance was same as Example 1 except that: a thickness of the obtained glass fiber cloth was 2.0 mm and the weaving density of warp or weft is 25 pieces/cm.

### Example 23

A thermal insulation felt with thermal shock resistance was same as Example 1 except that a thickness of the obtained glass fiber cloth was 2.0 mm and the weaving density of warp or weft is 30 pieces/cm.

### Example 24

A thermal insulation felt with thermal shock resistance was same as Example 1 except that, the glass fiber layer was the glass fiber felt obtained by needling: the glass fiber was cut into a single fiber filament, the fiber filament was entangled to obtain a glass fiber net, and then the needle machine was used to puncture the glass fiber net, and the fibers were wound and reinforced with each other to obtain a glass fiber felt, a thickness of the obtained glass fiber cloth was 2.0 mm, and a weaving density of warp or weft was 15 pieces/cm.

The performance test of the thermal insulation felt obtained in above Examples 20-24 were tested, and their thermal insulation performance and thermal shock resistance were tested respectively. The average values of the measurement results were taken and recorded in the following table:

| | Test items | |
|---|---|---|
| | Thermal insulation | Thermal shock resistance |
| | performance | Breakage time |
| | Thermal conductivity | under 1000° C. |
| Groups | W/(K · m)@25° C. | and 5 Bar (min) |
| Example 1 | 0.035 | 85 |
| Example 20 | 0.043 | 73 |
| Example 21 | 0.029 | 92 |
| Example 22 | 0.033 | 89 |
| Example 23 | 0.030 | 91 |
| Example 24 | 0.027 | 83 |

It can be seen from the above table that, the thermal insulation felt obtained in Examples 20-24 had better thermal insulation performance and thermal shock resistance. The thermal conductivity at 25° C. was only 0.027-0.043 W/(K·m), and the breaking time at 1000° C. and 5 Bar pressure was up to 73-92 min. This showed that the glass fiber layer with above thickness and weaving density all had better using effect. And, when the weaving density was fixed, the thicker the thickness, the better the thermal insulation performance.

It also can be seen from the above table that, the thermal insulation performance and thermal shock resistance of the glass fiber layer of Example 21 were excellent. The thermal conductivity at 25° C. was only 0.029 W/(K·m), and the breaking time at 1000° C. and 5 Bar pressure was up to 92 min, so that the Example 21 was the best example. When a thickness of the glass fiber cloth was 3.0 mm and a weaving density of warp or weft was 15 pieces/cm, the thermal insulation performance of thermal insulation felt was the best.

It also can be seen from the above table that, when the glass fiber layer was glass fiber felt, its thermal insulation performance was improved, and the thermal shock resistance was decreased slightly. Referring to Example 24, the thermal conductivity at 25° C. was only 0.027 W/(K·m), and the breaking time at 1000° C. and 5 Bar pressure was up to 83 min, so that the Example 24 was the best example. When the glass fiber layer was glass fiber felt, the thermal insulation performance of the thermal insulation felt was better. The reason was that, compared with glass fiber cloth, due to a more disordered distribution of inter-fiber voids in glass fiber felt, it was conducive to further improve its thermal insulation performance, but the structure was lighter and looser, and its tensile strength and thermal shock resistance was decreased slightly.

In summary, when the glass fiber cloth and glass fiber felt were used as the glass fiber layer, they had better using effect, and the thickness was higher, the thermal insulation performance was better. If the weaving density was too loose, there were few binding sites of glass beads. If the weaving density was too dense, it would affect the injection of glass beads, and the thermal insulation and temperature resistance of thermal insulation felt were declined.

### Example 25

A thermal insulation felt with thermal shock resistance was same as Example 1 except that the glass fiber was Z-Tex Plus™.

### Example 26

A thermal insulation felt with thermal shock resistance was same as Example 1 except that the glass fiber was Z-Tex Super™.

### Example 27

A thermal insulation felt with thermal shock resistance was same as Example 1 except that the glass fiber was Z-Tex Ultra™.

### Example 28

A thermal insulation felt with thermal shock resistance was same as Example 1 except that the glass fiber was obtained by compounding Z-Tex Plus™ and Z-Tex Ultra™ according to a weight ratio of 1:1.

### Example 29

A thermal insulation felt with thermal shock resistance was same as Example 1 except that, the glass fiber was a commercially available glass fiber, with a length of 25 mm and a diameter of 10 μm, grade CR21-2400, purchased from Wuhu Baiyun Glass Fiber Co., Ltd.

The performance test of the thermal insulation felt obtained in above Examples 25-29 were tested, and their thermal insulation performance and thermal shock resistance were tested respectively. The average values of the measurement results were taken and recorded in the following table:

| | Test items | |
|---|---|---|
| | Thermal insulation | Thermal shock resistance |
| | performance | Breakage time |
| | Thermal conductivity | under 1000° C. |
| Groups | W/(K · m)@25° C. | and 5 Bar (min) |
| Example 1 | 0.035 | 85 |
| Example 25 | 0.035 | 86 |
| Example 26 | 0.034 | 88 |
| Example 27 | 0.032 | 92 |
| Example 28 | 0.029 | 93 |
| Example 29 | 0.13 | 67 |

It can be seen from the above table that the thermal insulation felt obtained in Examples 25-28 had better thermal insulation performance and thermal shock resistance. The thermal conductivity at 25° C. was only 0.029-0.035 W/(K·m), and the breaking time at 1000° C. and 5 Bar pressure was up to 86-93 min. This showed that the above-mentioned glass fibers had excellent application effects, and the glass fiber layers prepared in the above-mentioned examples can effectively ensure a thermal insulation performance and thermal shock resistance of the thermal insulation felt.
In particular, the temperature resistance and thermal insulation performance of the glass fiber in Examples 25-28 were increased in turn, it can be seen that Z-Tex Ultra™ was preferably glass fiber layers. When a plurality of groups of glass fibers were compounded, a number and disorder of a gap were increased. Therefore, a binding site of glass beads at the same weaving density was increased, and it was conducive to fill glass beads and ensure a thermal insulation performance and thermal shock resistance of the thermal insulation felt.

It also can be seen from the above table that, compared with Example 1, in Example 29, the thermal conductivity at 25° C. was as high as 0.13 W/(K·m), which was increased by 271% than Example 1, and the breaking time at 1000° C. and 5 Bar air pressure was only 67 min, which was only reduced by 21% than Example 1. It can be seen that the glass fibers used in the present application can effectively protect the performance of the final product.

In summary, a choice of glass fiber and a final performance of the product was closely related. The glass fiber layer woven from the above types of glass fiber, after being filled by glass beads, had a compact and stable structure, and was not easy to deform due to heat and other reasons. It also can provide more binding sites for the thermal shock-resistant coating, and the combination of thermal shock-resistant coating is firmer and denser.

### Example 30

A thermal insulation felt with thermal shock resistance was the same as Example 1 except that, calculated as a percentage by weight, the composition and content of raw materials were as follows: 60% SiO₂, 10% Al₂O₃ and 30% ZrO₂.

### Example 31

A thermal insulation felt with thermal shock resistance was the same as Example 1 except that, calculated as a percentage by weight, the composition and content of raw materials were as follows: 60% SiO₂, 30% Al₂O₃ and 10% ZrO₂.

### Example 32

A thermal insulation felt with thermal shock resistance was the same as Example 1 except that, calculated as a percentage by weight, the composition and content of raw materials were as follows: 40% SiO₂, 50% Al₂O₃ and 10% ZrO₂.

### Example 33

A thermal insulation felt with thermal shock resistance was the same as Example 1 except that the filler was aerogel SiO₂ with a particle size of 0.5 mm.

The thermal insulation performance and thermal shock resistance of the thermal insulation felt obtained in above Examples 30-33 were tested, and their thermal insulation performance and thermal shock resistance were tested respectively. The average values of the measurement results were recorded in the following table:

| | Test items | |
|---|---|---|
| | Thermal insulation | Thermal shock resistance |
| | performance | Breakage time |
| | Thermal conductivity | under 1000° C. |
| Groups | W/(K · m)@25° C. | and 5 Bar (min) |
| Example 1 | 0.035 | 85 |
| Example 30 | 0.030 | 88 |
| Example 31 | 0.029 | 89 |
| Example 32 | 0.034 | 86 |
| Example 33 | 0.039 | 80 |

It can be seen from the above table that the thermal insulation felt obtained in Examples 30-33 had better thermal insulation performance and thermal shock resistance. The thermal conductivity at 25° C. was only 0.029-0.039 W/(K·m), and the breaking time at 1000° C. and 5 Bar pressure was up to 80-89 min. This showed that the hollow glass beads in the above composition not only had better filling effect with the glass fiber layer, but also rendered the glass fiber layer excellent high-temperature resistance and heat insulation performance through its own high-temperature resistance.

It also can be seen from the above table that, when the filler was aerogel SiO₂, it still had better thermal insulation performance and thermal shock resistance, but which was decreased to different degrees compared with hollow glass beads. Referring to Example 33, the thermal conductivity at 25° C. was only 0.039 W/(K·m), and the breaking time at 1000° C. and 5 Bar air pressure was up to 80 min. It can be seen that the hollow glass beads were better fillers. The reason was that the glass beads in the above components had denser structure, higher hardness and lower thermal conductivity. When the glass beads were combined with the glass fiber layer, they can effectively exert their thermal insulation performance and thermal shock resistance. The aerogel SiO₂ can also bring better insulation performance, but it was limited by structure characteristics of aerogel filler, which was not conducive to thermal shock resistance and mechanical properties of the thermal insulation felt.

### Example 34

A thermal insulation felt with thermal shock resistance was same as Example 1 except that, the particle size of the insulating glass beads was 50 μm, and the weight ratio of the insulating glass beads and glass fiber cloth was 1:3.

### Example 35

A thermal insulation felt with thermal shock resistance was same as Example 1 except that, the particle size of the insulating glass beads was 50 μm, and the weight ratio of the insulating glass beads and glass fiber cloth was 1:7.

### Example 36

A thermal insulation felt with thermal shock resistance was same as Example 1 except that, the particle size of the insulating glass beads was 10 μm, and the weight ratio of the insulating glass beads and glass fiber cloth was 1:5.

### Example 37

A thermal insulation felt with thermal shock resistance was same as Example 1 except that, the particle size of the insulating glass beads was 100 μm, and the weight ratio of the insulating glass beads and glass fiber cloth was 1:5.

The performance test of the thermal insulation felt obtained in above Examples 34-37 were tested, and their thermal insulation performance and thermal shock resistance were tested respectively. The average values of the measurement results were taken and recorded in the following table:

| | Test items | |
|---|---|---|
| | Thermal insulation | Thermal shock resistance |
| | performance | Breakage time |
| | Thermal conductivity | under 1000° C. |
| Groups | W/(K · m)@25° C. | and 5 Bar (min) |
| Example 1 | 0.035 | 85 |
| Example 34 | 0.040 | 84 |
| Example 35 | 0.031 | 86 |
| Example 36 | 0.029 | 89 |
| Example 37 | 0.071 | 83 |

It can be seen from the above table that the thermal insulation felt obtained in Examples 34-37 had better thermal insulation performance and thermal shock resistance. The thermal conductivity at 25° C. was only 0.029-0.071 W/(K·m), and the breaking time at 1000° C. and 5 Bar pressure was up to 83-89 min. This showed that the glass beats with above filling ratios and particle sizes can efficiently improve the thermal insulation performance and thermal shock resistance of the thermal insulation felt. When the particle size was certain, the filling proportion was more, the thermal insulation performance was better. However, based on the actual using demand and production cost, it was preferred that the proportion of the hollow glass beads to glass fiber cloth was 1:(3-7). In other examples, a higher proportion can also be selected, which should not be regarded as a limitation of the present application.

It also can be seen from the above table that, referring to Examples 1 and 36-37, when the particle size of the glass beads was changed, its thermal insulation performance and thermal shock resistance also change accordingly. The thermal conductivity at 25° C. was only 0.029-0.071 W/(K·m), and the breaking time at 1000° C. and 5 Bar pressure was up to 83-89 min. When other conditions were the same, the particle size of vacuum glass beads was smaller, its performance was better. The reason was that the filling compactness and strength were higher due to the small particle size.

In summary, in addition to further ensuring the compactness and strength of the hollow glass beads filled with the glass fiber layer, the hollow glass beads with the above particle size and specific gravity were not easy to affect the uniformity and bonding strength of the coating, thereby ensuring the high-temperature resistance and heat insulation performance of the glass fiber layer.

### Example 38

A thermal insulation felt with thermal shock resistance was same as Example 1 except that the coupling agent was KH-570.

### Example 39

A thermal insulation felt with thermal shock resistance was same as Example 1 except that the coupling agent was KH-602.

### Example 40

A thermal insulation felt with thermal shock resistance was same as Example 1 except that the coupling agent was KH-792.

### Example 41

A thermal insulation felt with thermal shock resistance was same as Example 1 except that the coupling agent was Sj-42.

### Example 42

A thermal insulation felt with thermal shock resistance was same as Example 1 except that the coupling agent was composed of KH-602 and KH-792 with a weight ratio of 1:1.

### Example 43

A thermal insulation felt with thermal shock resistance was same as Example 1 except that the coupling agent was composed of KH-550 and KH-570 with a weight ratio of 1:1.

The performance test of the thermal insulation felt obtained in above Examples 38-43 were tested, and their thermal insulation performance and thermal shock resistance were tested respectively. The average value of the measurement results was taken and recorded in the following table:

| | Test items | |
|---|---|---|
| | Thermal insulation | Thermal shock resistance |
| | performance | Breakage time |
| | Thermal conductivity | under 1000° C. |
| Groups | W/(K · m)@25° C. | and 5 Bar (min) |
| Example 1 | 0.035 | 85 |
| Example 38 | 0.035 | 84 |
| Example 39 | 0.036 | 85 |
| Example 40 | 0.036 | 85 |
| Example 41 | 0.035 | 84 |
| Example 42 | 0.034 | 86 |
| Example 43 | 0.032 | 87 |

It can be seen from the above table that, the thermal insulation felts obtained in Examples 38-43 all had better thermal insulation performance and thermal shock resistance. The thermal conductivity at 25° C. was only 0.032-0.036 W/(K·m), and the breaking time at 1000° C. and 5 Bar pressure was up to 84-87 min. This showed that the coupling agents of the above components can effectively improve the thermal insulation performance and thermal shock resistance of the thermal insulation felt. When multi-component coupling agent were used in combination at the same time, the performance was improved more significantly.

It also can be seen from the above table that, the thermal insulation felts obtained in Example 43 all have excellent performance and thermal shock resistance. The thermal conductivity of the thermal insulation felt at 25° C. was only 0.032 W/(K·m), and the breaking time at 1000° C. and 5 Bar pressure was up to 87 min. It can be seen that Example 43 was a preferred Example, when the coupling agent was composed of KH-550 and KH-570 in a weight ratio of 1:1, the thermal insulation performance of the thermal insulation felt was optimal.

In summary, the silane coupling agent in the above components can effectively improve a connection strength of the thermal shock-resistant coating and the glass fiber layer, and then the thermal shock-resistant coating can be firmly combined on two sides of the glass fiber layer and play a protective and insulating role, and when a plurality of groups silane coupling agent were compounded, they can form a cross-connection of the three-dimensional space structure, with a stronger structure and better viscosity.

The above are the preferred examples of the present application, which are not intended to limit the protection scope of the present application. Therefore, all equivalent changes made according to the structure, shape and principle of the present application should be covered within the protection scope of the present application.

What is claimed is:

1. A thermal insulation felt with thermal shock resistance, wherein, the thermal insulation felt with thermal shock resistance has a layered structure and comprises a glass fiber layer with a filler and a thermal shock-resistant coating, and the thermal shock-resistant coating is coated on one or both sides of the glass fiber layer with a filler;
the filler is hollow glass bead or aerogel SiO₂;
the thermal shock-resistant coating is obtained by coating a thermal shock-resistant coating material on one or two sides of the glass fiber layer with filler and then drying and solidifying; and
the thermal shock-resistant coating material, calculated as a percentage by weight, comprises 10-50% of SiO₂, 5-60% of ZnO, 5-40% of Al₂O₃, 5-15% of poly tetra fluoroethylene, 5-35% of silane coupling agent, and 15-50% of phosphate.

2. The thermal insulation felt with thermal shock resistance according to claim 1, wherein, the thermal shock-resistant coating has a thickness of 0.02-1.5 mm, and the drying and solidifying comprise solidifying at 250-500° C. for 1-5 h.

3. The thermal insulation felt with thermal shock resistance according to claim 1, wherein, the phosphate in the thermal shock-resistant coating material is one or more selected from a group consisting of dihydrogen phosphate, hydrogen phosphate, orthophosphate and metaphosphate.

4. The thermal insulation felt with thermal shock resistance according to claim 1, wherein, a glass fiber layer of the glass fiber layer with a filler is glass fiber cloth or glass fiber felt, and the glass fiber cloth or glass fiber felt is made of glass fiber; and
the glass fiber layer has a thickness of 1.0-3.0 mm, and a weaving density of warp or weft of 15-30 pieces/cm.

5. The thermal insulation felt with thermal shock resistance according to claim 4, wherein, the glass fiber is a continuous glass fiber with a diameter of 6-24 μm.

6. The thermal insulation felt with thermal shock resistance according to claim 1, wherein, the hollow glass bead, based on weight percentage, comprises 50-80% of SiO₂, 10-70% of Al₂O₃ and 10-30% of ZrO₂.

7. The thermal insulation felt with thermal shock resistance according to claim 6, wherein, a glass fiber layer of the glass fiber layer with a filler is glass fiber cloth or glass fiber felt, the hollow glass bead has a diameter of less than or equal to 100 μm, and a weight ratio of the hollow glass beads to the glass fiber cloth or the glass fiber felt is 1:(3-7).

8. The thermal insulation felt with thermal shock resistance according to claim 1, wherein, the silane coupling agent is one or more selected from a group consisting of KH-550, KH-570, KH602, KH792 and Sj-42.

9. A preparation method of the thermal insulation felt with thermal shock resistance according to claim 1, comprising the following steps:
S1. preparing a glass fiber layer;
S2. injecting a filler into the glass fiber layer to obtain the glass fiber layer with a filler; and
S3. Coating the thermal shock-resistant coating material on two sides of the glass fiber layer with a filler by one method selected from a group consisting of roller coating, calendering and scraping, wherein the coating comprises coating the thermal shock-resistant coating material to have a thickness of 0.02-1.0 mm; and solidifying at a temperature of 250-500° C. for 1-5 h to obtain the thermal insulation felt with thermal shock resistance.

10. The preparation method of the thermal insulation felt with thermal shock resistance according to claim 9, wherein, the glass fiber layer is a glass fiber cloth obtained by a weaving method or a glass fiber felt prepared by one method selected from a group consisting of needling, wet method, and dry method.

11. A thermal shock-resistant coating material, based on weight percentage, comprising 10-50% of SiO2, 5-60% of ZnO, 5-40% of Al₂O₃, 5-15% of PTFE, 5-35% of silane coupling agent and 15-50% of phosphate.
